(19) United States
(12) Patent Application Publication
(10) Pub. No.: US 2020/0223545 A1
(43) Pub. Date: Jul. 16, 2020

(54) AIRCRAFT CONTROL SYSTEM

(71) Applicant: BAE Systems plc, London (GB)

(72) Inventors: Paul Brooks, Farnborough (GB); Jonathan David Dixon, Farnborough (GB); Darryl James Sergison, Farnborough (GB)

(73) Assignee: BAE Systems plc, London (GB)

(21) Appl. No.: 16/632,427

(22) PCT Filed: Jul. 4, 2018
(86) PCT No.: PCT/GB2018/051885

§ 371 Date: Jan. 20, 2020

(30) Foreign Application Priority Data
Jul. 20, 2017 (GB) 1711651.8

(51) Int. Cl. B64C 39/02; B64D 27/24

(52) U.S. Cl. CPC B64C 39/024; B64D 27/24; B64D 2211/00; B64C 2201/042; B64C 2201/165; B64C 2201/021; B64C 2201/126; B64C 2201/108

(57) ABSTRACT

The present invention provides a pod (100) for an aircraft (1000), comprising: a housing (1); a unit (2) comprising a propulsion system, the unit comprising at least one attachment point (5) for coupling the unit to the housing (1), wherein the position of the unit relative to the housing is selected from a plurality of positions based on the centre of gravity of the aircraft, such that deflection of control surfaces required for the aircraft to maintain a constant angle of attack is minimised. The invention also provides an aircraft (1000) having the pod (100) and a method of balancing the aircraft (1000).

The present invention relates to a unit for controlling an aircraft, and a pod and aircraft having the unit.

The disclosure relates to unmanned, solar powered aircraft operating within the stratosphere (altitudes exceeding 18 km) for periods expected to exceed a year in duration. These aircraft are commonly referred to as High Altitude Long Endurance (HALE) aircraft. HALE aircraft are characterised by their large (tens of metres) wingspan, use of solar arrays for collecting the sun's energy, low power propulsion systems, low mass and high capacity, light weight batteries for power storage.

Designing and operating such aircraft requires several problems to be overcome which are not normally experienced by conventional manned aircraft or unmanned aircraft operating at lower altitudes. These are caused by the environment in which HALE aircraft operate, the payloads carried and the duration of the missions that they undertake.

Flight duration is primarily determined by battery power over the yearly cycle using solar power as the energy source. During daylight hours there is an abundance of energy to power the aircraft but at night energy must be provided by batteries which are constrained by their operating temperatures and the degradation of their capacity over time. To extend flight duration requires that the power needed to fly overnight is minimised whilst the energy available from the batteries is maximised. The energy losses from this optimum position occur through the aerodynamic drag of the airframe, the mass of the aircraft, the power required to maintain systems, particularly the temperature of the batteries. The energy available from the batteries decreases through the loss of usable capacity as their temperature is reduced.

To achieve the objective of long duration flight the thermal design of HALE aircraft must strike a balance between mass and power. In particular the management of power within a solar powered aircraft is a defining feature of the aircraft's design because it affects the aerodynamics, mass and power usage of the aircraft. HALE aircraft are customarily designed to be aerodynamically efficient and constructed from ultra-light weight materials to reduce the overall mass of the aircraft. However, one area where mass is added is in the connections between components within the aircraft. The wiring harnesses connect solar arrays, batteries, sensor, actuators, control & propulsion systems. As the harnesses are conventionally made from metal wire they can add considerable mass to the aircraft. Any reduction of the amount of harness required can have a significant effect on the overall mass of the aircraft.

Within the stratosphere an aircraft experiences temperatures in the region of −60° C. in flight and the effective capacity of batteries reduces rapidly with temperatures below +20° C., as a result the batteries require heating and insulation in order to maintain a useful capacity. However, providing additional heating requires power which decreases the power available for propulsion which in turn reduces the flight duration. Heating requirements therefore are normally reduced by adding thermal insulation. Thermal insulation material and heating circuits both add mass to the aircraft which again has the effect of increasing the power required to fly. It is therefore advantageous to reduce the amount of active heating and thermal insulation required and to conserve power by utilising any heat generated by the aircraft or its systems during operation.

HALE aircraft act as platforms for various types of payload. A single aircraft may be required to carry different payloads on each mission or multiple payloads for one mission. Since the mass of the payloads and their location on the aircraft may vary they have a significant affect the overall centre of gravity of the airframe and thereby the stability of the aircraft in flight. Changes in the mass of batteries, propulsion and avionics equipment also to a lesser extent have a similar effect. To counteract these changes the aircraft must be carefully balanced to re-adjust the centre of gravity of the airframe and tested to ensure stability when a new payload is fitted. This process increases the turn round time between missions and thereby adds to the operational cost of the aircraft.

A simple system to counteract changes in the centre of gravity when new payloads or components are introduced is therefore beneficial to the operating cost over the aircraft's lifetime.

As the technologies behind the components within the aircraft change over time there is a need to replace existing parts e.g. batteries, motors or avionics or add completely new components when they become available. Current HALE aircraft design integrates key system components into the aircraft structure itself. For example, housing batteries on the aircraft requires some form of enclosure which does not compromise the aerodynamic shape of the aircraft. The propulsion system may also be fully integrated into the airframe.

The close integration of components with the airframe is disadvantageous as any changes can mean that the airframe must be redesigned, rebuilt and retested to meet industry safety standards. This can involve the retesting of large sections of the airframe or, in some instances, the entire aircraft for functional correctness under the expected environmental conditions at high altitude. Undertaking testing at low temperatures, low pressures or higher radiation levels requires larger scale environmental testing facilities when testing large sections of an aircraft. These facilities are expensive to buy or hire. A small change can therefore represent a large overhead in time and money. Decoupling an aircraft's systems from the airframe into a small, discrete, removable unit that can be tested using smaller, cheaper and more readily available facilities can have a significant effect in reducing the time, cost and the complexity of testing.

The concept of a single unit that contains control and power systems is unusual but not a new one for manned aircraft. For example, it is known to attach engine nacelles to wings of aircraft, the nacelles including propulsion devices and control systems for e.g. controlling fuel injection into a combustion chamber. Nor is the concept of an unmanned aircraft whereby various parts of the aircraft can be replaced; for example tyres can be replaced if they develop a puncture. None of these prior concepts address the constraints imposed by operating in a high altitude environment requiring the optimisation of the unit for temperature, pressure, aerodynamic drag and mass.

According to a first aspect of the present invention, there is provided a removable or integrated pod attached to an unmanned aircraft comprising of an aerodynamically shaped outer housing and a removable inner aircraft in a box (AIB) being arranged such that the AIB consists of: a frame; thermal insulation; a heating system; a power storage system; a propulsion system; optionally, an aircraft control system; one or more connections for attaching the systems within the AIB to the aircraft.

The pod may be integrated into the airframe. Alternatively, the pod may be connected to the airframe by a means of attachment. The means of attachment may be a plurality of mechanical fastenings. Alternatively, the means of attachment may be an adhesive joint.

The shape of the housing may be designed to accommodate the AIB in a way that reduces the drag on the airframe to a minimum.

The thermal insulation may minimise heat loss through conduction, convection and radiation. The thermal insulation may be attached to the inner side of the housing.

According to a second aspect of the present invention, there is provided a plurality of pods according to the first aspect attached to an unmanned solar powered aircraft.

The power storage system may be a plurality of batteries. The batteries may be assembled into a volume with dimensions that maximise the useful energy available from the said batteries.

The heating system may be a plurality of electrical heating elements.

An aircraft control system may include RF communication equipment. An aircraft control system may include avionics hardware.

The propulsion system may include a motor controller, a motor and a propeller.

The structural frame may fully enclose the thermal insulation, the heating system, the power storage system, the aircraft control system and the motor controller. The motor and propeller may be attached to the end of the structural frame and to the motor controller.

The power storage system may be connected to the aircraft control system and the motor controller by a short length of wire. The aircraft control system may be connected to the power storage system and the motor controller by a short length of cable. The power storage system may be connected to a power bus which is also connected to a solar power source and power consuming equipment on the aircraft. The aircraft control system may be connected to a control bus which is also connected to other equipment on the aircraft that is controlled by the aircraft control system.

The thermal insulation may be a material that minimises heat loss through conduction, convection and radiation. The thermal insulation may be composed of a plurality of layers of thermal insulation. The thermal insulation may be located between the structural frame and the heating system.

The heating system may be located between the thermal insulation and the power storage system. The heating system elements may be attached to the thermal insulation.

The temperature sensors may be positioned between the batteries.

The AIB may be inserted horizontally into the housing on a plurality of locating guides. The locating guides may be located at the top and bottom of the inside of the housing and extend at right angles to the side of the housing. The AIB may be horizontally positioned within the housing such that the centre of gravity of the aircraft can be altered. The AIB may be attached to the housing by a means of attachment points.

According to a third aspect of the present invention, there is provided a method of maintaining the power storage equipment at an optimal operating temperature comprising of: Generating heat by operating the aircraft propulsion equipment and, if fitted, aircraft control equipment during operation. Reducing heat loss to the surrounding environment by using the thermal insulation fitted to the housing and the AIB. Monitoring the internal temperature of the batteries using sensors embedded between the batteries. Activating the heat generating equipment when the temperature is below that required for the power storage equipment to operate optimally.

According to a fourth aspect of the present invention, there is provided a method for utilising the pod: Design, test and manufacture a pod and one or more configurations of the AIB. Prior to a launch fit one or more pods to the airframe of a solar powered aircraft. Fit the payload for the mission is also fitted. Move the AIB within the housing to adjusted the aircraft's centre of gravity taking into account the payload's position. Undertake a flight of the solar powered aircraft. On completion of the flight remove the AIB and replaced it or fit an upgraded AIB with new equipment. e.g. higher capacity, lighter weight batteries or a new system to be added to the aircraft. Launch the aircraft and executes the next mission. Refurbished the removed AIB by, for example, replacing the batteries. When battery capacity is no longer sufficient to complete a mission or fault occurs with the propulsion system discard the AIB.

According to a fifth aspect of the present invention, there is provided a pod for an aircraft, comprising:
a housing;
a unit comprising a propulsion system, the unit comprising at least one attachment point for fixing the unit within the housing, wherein the position of the unit relative to the housing is selected from a plurality of positions based on the centre of gravity of the aircraft such that deflection of control surfaces required for the aircraft to maintain a constant angle of attack is minimised.

The unit may be slidable within the housing in order to be moved to the selected position.

The position of the unit may be selectable from one of a plurality of positions along a longitudinal axis of the housing. Additionally or alternatively, the position of the unit may be selectable from one of a plurality of positions along a lateral axis of the housing.

The pod may comprise a processor configured to:
calculate the centre of gravity of the aircraft while the aircraft is in flight;
select a position of the unit relative to the housing based on the calculated centre of gravity; and
actuate a control mechanism to move the unit to the selected position

A spacer of a predetermined thickness may be disposed between the attachment point and the housing, and wherein the thickness of the spacer is selected such that the unit is attachable to the housing such that the unit is disposed at the selected position relative to the housing.

The housing may comprise at least one locating guide onto which the unit is mounted in order to be slid within the housing.

The attachment points may be spaced apart along the longitudinal axis of the housing.

The at least one locating guide may be located at the top and/or bottom of the inside of the housing and extends at right angles to the side of the housing.

The unit may comprise:
a control system for controlling aircraft systems;
a motor, motor controller and a propeller extending from the unit for providing thrust to the aircraft;
a power storage system for storing power to power the aircraft; and
a frame for holding the control system, propulsion system and power storage system.

The power storage system may comprise a plurality of batteries arranged in layers.

The unit may be replaceable.

The shape of the housing may be optimised for maintaining a thermal state within the housing and for decreasing aerodynamic drag when the aircraft is in flight.

According to a sixth aspect of the present invention, there is provided an aircraft comprising at least one pod according to the fifth aspect, wherein a longitudinal axis of the pod is substantially parallel with a longitudinal axis of the aircraft.

The at least one pod may be coupled to or integrated with a wing of the aircraft.

The aircraft may comprise an interchangeable payload attached to the nose or tail end of the aircraft.

The aircraft may be an unmanned solar powered aircraft.

According to a seventh aspect of the present invention, there is provided a method of balancing an aircraft such that deflection of control surfaces required for the aircraft to maintain a constant angle of attack is minimised, the aircraft comprising at least one pod according to the fifth aspect, the method comprising:
calculating a first centre of gravity of the aircraft in a predetermined configuration;
calculating a second centre of gravity of the aircraft in a present configuration;
if the difference between the first centre of gravity and the second centre of gravity is greater than a threshold, selecting a position of the unit relative to the housing to move the second centre of gravity closer to the first centre of gravity; and
fixing the unit within the housing, such that the unit is disposed at the selected position relative to the housing.

The method may comprise selecting a thickness of a spacer to dispose between the housing of the pod and an attachment point of the unit, the thickness of the spacer being selected such that the unit is attachable to the housing such that it is disposed at the selected position relative to the housing.

The method may comprise calculating the moment generated by the payload mass and location.

The method may comprise moving the unit to a selected position during the flight of the aircraft.

The unit may comprise:
a control system for controlling aircraft systems;
a motor, motor controller and a propeller extending from the unit for providing thrust to the aircraft;
a power storage system for storing power to power the aircraft; and
a frame for holding the control system, propulsion system and power storage system.

Aspects of the invention described herein tend to address the issues arising from operating in high altitude environments by proposing a unit optimised for the environmental constraints and the for long duration flights. Aspects of the invention reside in the localisation of all aircraft systems, including the propulsion system, in an optimised unit that can be used to adjust the centre of gravity of the aircraft and which can be replaced as required without any alteration to the airframe.

Thus there is proposed a thermally efficient, aerodynamically shaped pod consisting of an outer housing and a removable inner unit, the aircraft in a box (AIB), into which the aircraft's power, control and propulsion systems are integrated and methods for its use. The pod is attached to the airframe of an aircraft, more particularly a solar powered HALE aircraft. The attachment means allows the pod to be permanently attached or to be removable. The pod may include further components, such as wiring.

The AIB housed within the pod can be configured so that it contains all the systems that are used to operate the aircraft or a subset thereof. The aircraft systems within the AIB are connected to other parts of the aircraft by power and communication connectors. Within the AIB they are connected to one another. The combined effect reduces the mass of wiring required to connect the systems on the aircraft together. The inner unit can be removed from the pod so that it can be easily replaced. It can also be moved horizontally within the pod to adjust the location of its mass relative to the airframe thereby altering the aircraft's centre of gravity.

The pod is constructed so that it maintains an optimal operating temperature for the aircraft systems housed within through the combined use of thermal insulation, heating systems and the use of heat generated as a by-product of the operation of those systems. The thermal system is applied in two parts; the first is on the inner surface of the pod and the second within the AIB. Where a power storage system is one of the aircraft systems housed within the AIB and it comprises of a number of batteries they are stacked into a cuboid structure thereby maximising the thermal efficiency of the pod.

Both the pod and the AIB can be removed and replaced. This allows technological changes in aircraft components to be introduced by upgrading the pod or AIB without the need to change the airframe itself.

The invention is described by reference to two embodiments and the accompanying drawings in which:

FIG. 1 shows the assembled pod integrated into the airframe.

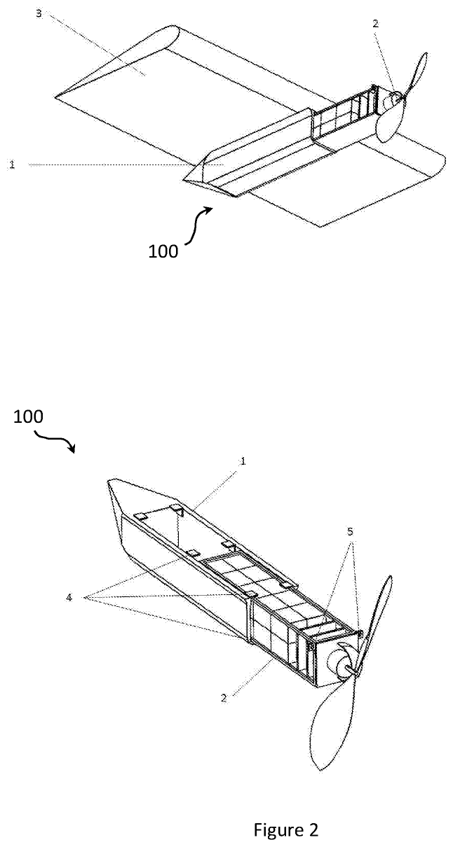

FIG. 2 shows the AIB and how it is installed into the outer housing of the pod.

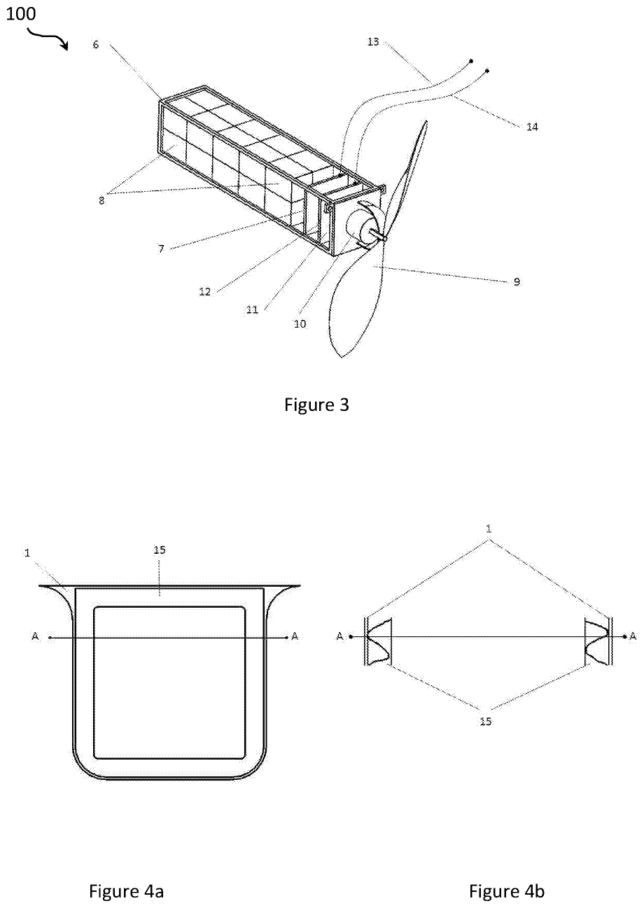

FIG. 3 shows an arrangement of power storage, propulsion & avionics system within the AIB of the pod.

FIGS. 4 a & b show two cross sections of the thermal insulation within the outer casing of the pod.

FIGS. 5 a & b show two cross sections of the thermal insulation within the AIB of the pod.

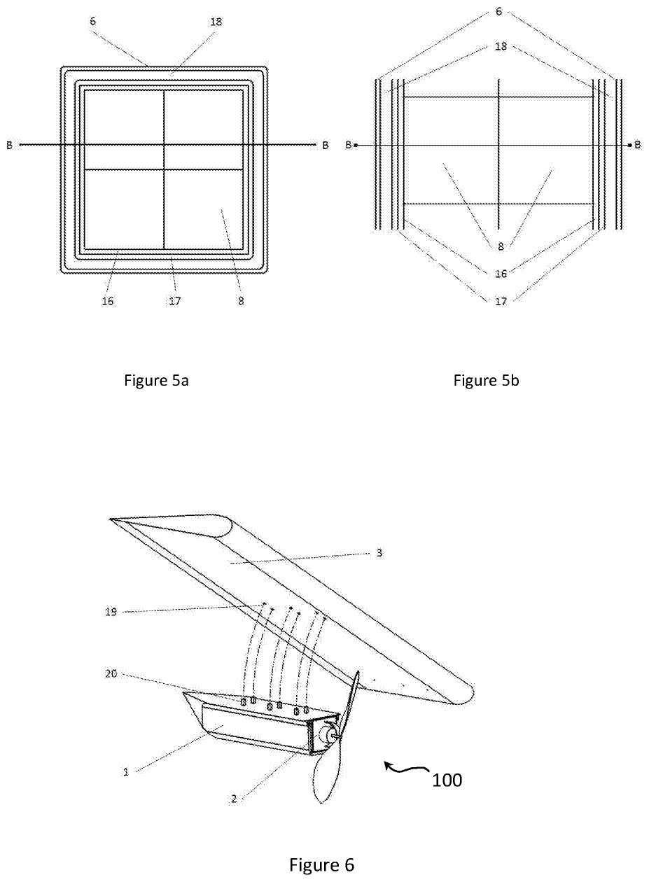

FIG. 6 shows the assembled removable pod and the mounting arrangement connecting the pod to the airframe.

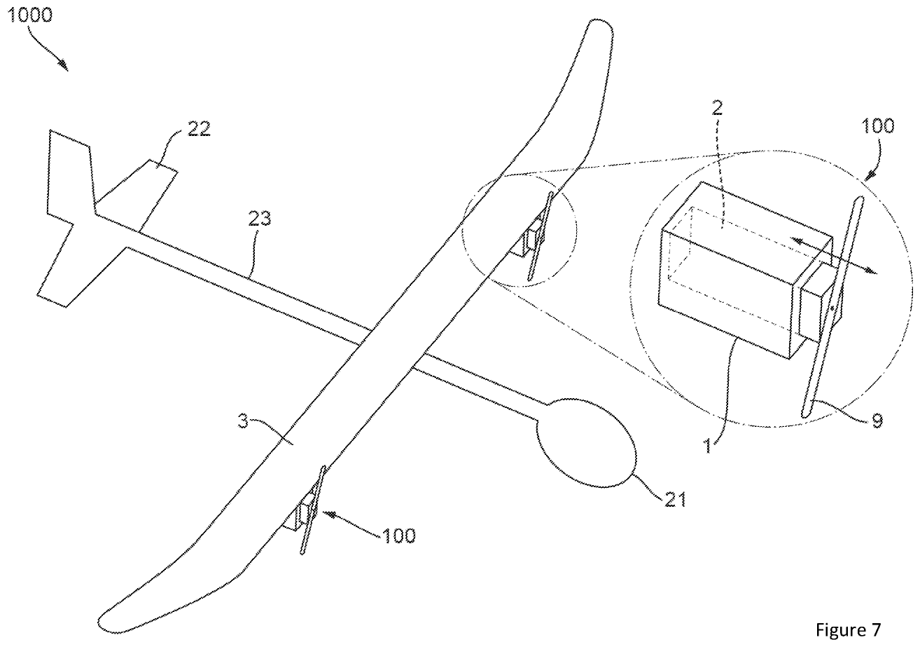

FIG. 7 shows a perspective view of an aircraft according to embodiments of the present invention.

FIG. 1 shows a pod 100 (or nacelle, or fairing) according to an embodiment of the present invention which is permanently attached to a wing of a solar powered high altitude unmanned aircraft. The pod 100 consists of an outer housing 1 and an inner unit, the AIB 2. The pod 100 may include other components, as explained below. The housing 1 is aerodynamically shaped to fit the AIB 2 and to reduce drag on the wing. This represents a compromise between a spherical shaped housing which is the optimal shape for maintaining the thermal state of the pod for a given volume of batteries and a long thin pod which is an optimal shape for decreasing aerodynamic drag.

In this embodiment the pod 100 is integrated into the aircraft wing 3, which transfers the structural load of the pod 100 mass to the aircraft structure. The attachment mechanism itself may be a low temperature adhesive or sealant.

FIG. 2 shows the removable AIB 2 within the housing 1. The housing 1 has a number of locating guides 4 and attachment points 5 that allow the AIB to be slid into the housing and secured. The AIB 2 is mounted on locating guides inside the housing which allow the AIB 2 to be slid horizontally into the housing. The AIB 2 can therefore be fitted quickly and easily into the pod 100.

The locating guides 4 allow the longitudinal position of the AIB to be changed to balance the centre of gravity of the aircraft. This would be required whenever the payload mass or location change. Suitable sized spacers may be placed between the housing and the AIB at the attachment points 5. The AIB can be attached to the housing 1 at the attachment points 5 by a securing device, such as a screw, bolt or clip.

FIG. 3 shows the internal structure of the AIB 2 in detail. It consists of a structural frame 6 which holds the batteries 8, the power control electronics board 7, the electronics used to control the aircraft 12 (avionics) and the propulsion system, comprising a motor 10, a motor controller 11 and a propeller 9. Electrical connectors are provided to link the power 13 and control systems 14 in the AIB to the solar array, actuators, sensors and equipment on the rest of the aircraft.

The structural, control and power interfaces are independent of the batteries used enabling the aircraft design to remain unchanged even when the batteries or other systems are changed when improved battery technology is available. The same would be true of changes to the avionics and propulsion systems as well.

Since the AIB contains all the aircraft systems required to operate components of the aircraft the AIB can be tested as a single, small unit then mass produced. The AIB can be removed and replaced quickly thereby reducing the turn round time between flights.

FIGS. 4a & 5a show the thermal control system that is fitted within the pod 100. Heat is generated within the pod 100 as a by-product of the operation of the motor 10, the power control 7, avionics 12, and propulsion control 11. This energy recovery maintains a higher temperature inside the housing 1 and the AIB 2.

Within the housing 1 the thermal insulating material 15 is permanently applied to the inner wall of the housing. A cross section view showing the composition of the housing is shown in FIG. 4b. This provides a thermal layer capable of retaining heat within the pod 100.

The AIB's thermal control system, shown in FIG. 5a, consists of one or more layers of thermal insulation 17, one or more heater elements 16 and temperature sensors located between or adjacent to the layers of batteries 8 which are the most temperature sensitive components in the AIB in this embodiment. The thermal control system is held between the structural frame 6 and the batteries 8 as shown in FIG. 5b such that a tolerance gap 18 is allowed between the frame 10 and thermal insulation 15 to account for changes in battery. Heat is generated within the AIB by the power control 7, avionics 12, and propulsion control 11 systems. Sensors interleaved within the stacks of batteries are connected to the power control equipment 7 which monitors the temperature against an optimal operating temperature for the batteries and activate/deactivate the heater elements 16 as required.

The thermal insulation is chosen to suit the thermal characteristic of the contents of the AIB. It is designed so that it maintains the batteries, electronics and propulsion system within their acceptable operating temperatures. As the thermal characteristics change, so may the thermal material used or its thickness.

One or more pods 100 may be integrated (i.e. integrally formed) into each wing 3 or the fuselage of the aircraft as required. The additional pods may have different configurations of aircraft system or thermal insulation within the AIB.

A second embodiment for a pod 100 (or nacelle) is shown in FIG. 6. This pod can be detached from the airframe.

The pod 100 contains (i.e. includes) a housing 1 and an AIB 2 as described in the preceding embodiment. The housing 1 has a number of attachment points 20 which fasten to corresponding points 19 on the airframe. Other forms of attachment are also possible such as, but not limited to, clips, screws, locking hooks, adhesive or latches.

The pod 100 can be easily removed, replaced or substituted for another pod without any change to the airframe itself.

The method of use of the invention is to design, and test a pod and one or more configurations of the AIB. When tested the pod and AIB can be mass produced and stored. Prior to a flight one or more pods are fitted to a solar powered HALE aircraft. The payload for the mission is also fitted and the AIB moved to adjust the aircraft's centre of gravity taking into account the payload's position. The aircraft is launched, executes its mission and lands. The AIB is removed and replaced with a new unit from the store. The payload may or may not be replaced. The aircraft is relaunched and executes its next mission. The discarded unit is refurbished by, for example replacing the batteries, and returned to storage.

When a technological upgrade of an aircraft system becomes available e.g. a higher capacity, lighter weight batteries or a new system is added to the aircraft a new AIB is designed, built, tested and manufactured. The thermal requirements of the new systems are assessed as part of the design process so that heating and insulation can be adapted to provide an optimal thermal environment for the systems within the AIB.

Existing aircraft can then be upgraded by fitted the new AIB 2 within the existing pod housing 1. There is no need to change the airframe to accommodate the technological advancement or the introduction of a new aircraft system.

FIG. 7 shows an aircraft 1000 having a pod 100 attached to each wing. Each pod 100 is orientated such their longitudinal axes substantially align with a longitudinal axis of the aircraft 1000 such as the central axis. In another embodiment, there may only be a single pod 100 coupled to the aircraft 1000, for example on the nose of the aircraft 1000. In another embodiment, there may be a plurality of pods 100 attached to each wing. The aircraft 1000 is a HALE aircraft, optimised for operating at high altitudes for long periods of time. Therefore, the aircraft is relatively lightweight and has wings 3 designed for generating large amounts of lift with little drag. The pod 100 contains a propulsion device, such as a tractor propeller or pusher propeller.

The aircraft 1000 includes a fuselage 23, tail surface 22, wings 3 and a payload 21. The payload 21 is attached to the aircraft 1000 at the end opposite to the tail surfaces 22. In other embodiments, a payload 21 may additionally or alternatively be disposed at the rear of the aircraft 1000. In another embodiment, the payload 21, or payloads, may be coupled to a wing 3 or wings of the aircraft 1000.

The payload 21 is interchangeable. In other words, the mass of the payload 21 may be different on each flight of the aircraft 1000 to accommodate different sensor or mission equipment. The payload 21 is for example a releasable satellite or weapon. The payload 21 may alternatively be designed not to be releasable, such as a sensor package. The length of fuselage between the payload 21 and wings 3 may also be different for each flight. The mass of the payload 21 and position of it relative to the rest of the aircraft 1000 generates a moment, counter balanced by the principal aircraft forces generated by the wings 3 and tail surface 22. The centre of gravity of the aircraft 1000 is calculated for each flight, which is dependent upon the payload 21 and its location.

Each pod 100 has a housing 1. An AIB 2 is disposed substantially within the housing 1, such that its propeller 9 protrudes from the housing 1. The AIB 2 is arranged to slide along a longitudinal axis of the housing 1 such that the propeller 9 protrudes further from the housing 1 or closer to the housing 1. It can then be fixed in the selected position. The AIB 2 may slide with the aid of a locating guide 4. There may be a plurality of locating guides 4. Additionally or alternatively, in some embodiments the AIB 2 is arranged to slide along a lateral axis of the housing 1. This tends to be desirable where a payload 21 is carried on a wing 3 of the aircraft 1000, which would induce a roll if the aircraft 1000 were not counterbalanced in some way.

When the desired position of the AIB 2 relative to the housing 1 is achieved, an attachment point 5 is used to couple the AIB 2 within or to the housing 1. In one embodiment, in order to retain the position of the AIB 2 relative to the housing 1, a spacer of a predetermined thickness is disposed between the attachment point 5 and the housing 1.

To improve the trim of the aircraft 1000, thereby reducing the elevator or aileron input (and thus drag) necessary to keep the aircraft 1000 flying straight and level, or at some other chosen angle of attack, the position of the AIB 2 in the housing 1 is adjusted using the spacer as previously described. A new centre of gravity can then be calculated to set the trim. By reducing drag, power consumption tends to be reduced.

The aircraft 1000 may be configured to release a payload 21 during flight. Releasing a payload 21, particularly where the payload 21 is heavy relative to the airframe of the aircraft 1000, can alter the aerodynamic performance of the aircraft 1000. This results in the trim of the aircraft 1000 having to be adjusted during flight to maintain a constant angle of attack. Therefore, in some embodiments, the pod 100 includes a processor for determining the new centre of gravity of the aircraft 1000, after the payload 21 has been released. The processor then determines a desired position of the AIB 2 within the housing 1 in order to alter the trim of the aircraft 1000, making it more balanced. A motor within the pod 100 can then be used to drive the AIB 2 to move to the desired position.

While the use of a spacer has been described as being used to set the distance to which the AIB 2 is inserted into the housing 2 in the embodiment above, in other embodiments, the spacer is not necessary, particularly where the position of the AIB 2 is adjustable during flight. For example, in some embodiments either the AIB 2 or the housing 1 are telescopic. In this latter case, reference to the position of the AIB 2, or propeller 9 of the AIB 2, relative to the housing 1, is in relation to the housing 1 prior to its extension.

What is claimed is:

1. A pod for an aircraft, comprising:
a housing;
a unit comprising a propulsion system, the unit comprising at least one attachment point for fixing the unit within the housing, wherein the position of the unit relative to the housing is selected from a plurality of positions based on the centre of gravity of the aircraft such that deflection of control surfaces required for the aircraft to maintain a constant angle of attack is minimised.

2. The pod according to claim 1, wherein the unit is slidable within the housing in order to be moved to the selected position.

3. The pod according to claim 1, wherein the position of the unit is selectable from one of a plurality of positions along a longitudinal axis of the housing.

4. The pod according to claim 1, comprising a processor configured to:
calculate the centre of gravity of the aircraft while the aircraft is in flight;
select a position of the unit relative to the housing based on the calculated centre of gravity; and
actuate a control mechanism to move the unit to the selected position.

5. The pod according to claim 1, wherein a spacer of a predetermined thickness is disposed between the attachment point and the housing, and wherein the thickness of the spacer is selected such that the unit is attachable to the housing such that the unit is disposed at the selected position relative to the housing.

6. The pod according to claim 1, wherein the unit comprises:
a control system for controlling aircraft systems;
a motor, motor controller and a propeller extending from the unit for providing thrust to the aircraft;
a power storage system for storing power to power the aircraft; and
a frame for holding the control system, propulsion system and power storage system.

7. The pod according to claim 6, wherein the power storage system comprises a plurality of batteries arranged in layers.

8. The pod according to claim 1, wherein the unit is replaceable.

9. An aircraft comprising at least one pod according to claim 1, wherein a longitudinal axis of the pod is substantially parallel with a longitudinal axis of the aircraft.

10. The aircraft according to claim 9, wherein the at least one pod is coupled to or integrated with a wing of the aircraft.

11. The aircraft according to claim 9, comprising an interchangeable payload attached to the nose or tail end of the aircraft.

12. The aircraft according to claim 9, wherein the aircraft is an unmanned solar powered aircraft.

13. A method of balancing an aircraft such that deflection of control surfaces required for the aircraft to maintain a constant angle of attack is minimised, the aircraft comprising at least one pod according to claim 1, the method comprising:
calculating a first centre of gravity of the aircraft in a predetermined configuration;
calculating a second centre of gravity of the aircraft in a present configuration;
if the difference between the first centre of gravity and the second centre of gravity is greater than a threshold, selecting a position of the unit relative to the housing to move the second centre of gravity closer to the first centre of gravity; and
fixing the unit within the housing, such that the unit is disposed at the selected position relative to the housing.

14. The method according to claim 13, comprising selecting a thickness of a spacer to dispose between the housing of the pod and an attachment point of the unit, the thickness of the spacer being selected such that the unit is attachable to the housing such that it is disposed at the selected position relative to the housing.

15. The method according to claim 13, wherein the unit comprises:
a control system for controlling aircraft systems;
a motor, motor controller and a propeller extending from the unit for providing thrust to the aircraft;
a power storage system for storing power to power the aircraft; and
a frame for holding the control system, propulsion system and power storage system.

16. The pod according to claim 2, wherein the position of the unit is selectable from one of a plurality of positions along a longitudinal axis of the housing.

17. The pod according to claim 2, comprising a processor configured to:
calculate the centre of gravity of the aircraft while the aircraft is in flight;
select a position of the unit relative to the housing based on the calculated centre of gravity; and
actuate a control mechanism to move the unit to the selected position.

18. The pod according to claim 3, comprising a processor configured to:
calculate the centre of gravity of the aircraft while the aircraft is in flight;
select a position of the unit relative to the housing based on the calculated centre of gravity; and
actuate a control mechanism to move the unit to the selected position.

19. The pod according to claim 2, wherein a spacer of a predetermined thickness is disposed between the attachment point and the housing, and wherein the thickness of the spacer is selected such that the unit is attachable to the housing such that the unit is disposed at the selected position relative to the housing.

20. The pod according to claim 3, wherein a spacer of a predetermined thickness is disposed between the attachment point and the housing, and wherein the thickness of the spacer is selected such that the unit is attachable to the housing such that the unit is disposed at the selected position relative to the housing.
